(19) United States
(12) Patent Application Publication
(10) Pub. No.: US 2026/0235158 A1
(43) Pub. Date: Aug. 13, 2026

(54) FOIL BEARING AND ROTATING MACHINE

(71) Applicant: MITSUBISHI HEAVY INDUSTRIES ENGINE & TURBOCHARGER, LTD., Sagamihara-shi, Kanagawa (JP)

(72) Inventors: Takaya FUTAE, Tokyo (JP); Hideaki NISHIDA, Tokyo (JP); Rimpei KAWASHITA, Tokyo (JP); Tasuku MASUDA, Tokyo (JP); Takuzo SHIGIHARA, Tokyo (JP); Akari MINAMI, Tokyo (JP); Takuma ONOGI, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 19/152,525

(22) PCT Filed: Feb. 24, 2023
(86) PCT No.: PCT/JP2023/006673

§ 371 Date: Jul. 31, 2025

(51) Int. Cl. F16C 17/24; F16C 17/02; F16C 27/02

(52) U.S. Cl. CPC F16C 17/24; F16C 17/024; F16C 27/02; F16C 2240/30; F16C 2360/24

(57) ABSTRACT

This foil bearing comprises a top foil, a bump foil, and a housing. The foil bearing comprises a cylindrical section which surrounds the bump foil and supports the bump foil from the outer periphery side of the bump foil. When a rotating direction of a shaft is defined as a forward direction of a circumferential position and an upper end position of an inner circumferential surface of the housing is defined as a 0° position in a circumferential direction in a cross-section orthogonal to a central axis of the housing, then a mean value of the distance between the central axis of the housing and an inner circumferential surface of the cylindrical section in a 160° to 200° range in the circumferential direction is smaller than a mean value of the distance between the central axis of the housing and the inner circumferential surface of the cylindrical section in a 0° to 360° range in the circumferential direction in the cross-section orthogonal to the central axis of the housing when in a state where the shaft is rotating and floating from a bearing surface.

### TECHNICAL FIELD

The present disclosure relates to a foil bearing and a rotating machine.

### BACKGROUND ART

PTL 1 discloses a foil bearing that includes a top foil, a bump foil, and a tubular housing surrounding the top foil and the bump foil. In this foil bearing, the bump foil is configured to include a support portion that comes into contact with an inner surface of the housing and that does not move in a circumferential direction, and a pleated elastic portion that is supported by the support portion and that is elastically bent in a radial direction due to a surface pressure from a back foil, and it is disclosed that vibration of a supported shaft is suppressed by adjusting a height or an angle of the pleat.

### CITATION LIST

### Patent Literature

[PTL 1] Japanese Unexamined Patent Application Publication No. 2009-299748

### SUMMARY OF INVENTION

### Technical Problem

In the foil bearing described in PTL 1, it is difficult in terms of manufacturing to finely adjust the height or angle of the complicated pleated elastic portion, and when a deviation or the like occurs in the height or angle of the pleat due to a manufacturing error or a change over time, the effect of suppressing the vibration of the shaft is likely to be limited.

In view of the above circumstances, an object of at least one embodiment of the present disclosure is to provide a foil bearing and a rotating machine including the foil bearing, in which it is possible to suppress vibration of a shaft with a simple configuration.

### Solution to Problem

In order to achieve the above object, a foil bearing according to at least one embodiment of the present disclosure includes:
a top foil that includes a bearing surface facing a shaft;
a bump foil that supports the top foil from an outer periphery side of the top foil; and
a tubular housing that accommodates the top foil and the bump foil,
in which the foil bearing includes a tubular portion that surrounds the bump foil and that supports the bump foil from an outer periphery side of the bump foil, and
when in a cross section orthogonal to a central axis of the housing, a position of an upper end of an inner peripheral surface of the housing is defined as a position of 0° in a circumferential direction of the housing and a rotation direction of the shaft is defined as a positive direction of a position in the circumferential direction,
in a state where the shaft rotates and floats from the bearing surface, in the cross section orthogonal to the central axis of the housing, an average value of distances between the central axis of the housing and an inner peripheral surface of the tubular portion in a range of 160° to 200° in the circumferential direction is smaller than an average value of distances between the central axis of the housing and the inner peripheral surface of the tubular portion in a range of 0° to 360° in the circumferential direction.

In order to achieve the above object, a rotating machine according to at least one embodiment of the present disclosure includes: the foil bearing described above; and the shaft.

### Advantageous Effects of Invention

According to at least one embodiment of the present disclosure, there are provided a foil bearing and a rotating machine including the foil bearing, in which it is possible to suppress vibration of a shaft with a simple configuration.

### BRIEF DESCRIPTION OF DRAWINGS

FIG. 1 is a diagram schematically showing an example of a cross section orthogonal to an axial direction in a foil bearing 2 according to one embodiment, and shows the foil bearing 2 in a state where a shaft 4 rotates and floats from a bearing surface 14.

FIG. 2 is a diagram schematically showing an example of a cross section of a foil bearing 02 according to a comparative form orthogonal to an axial direction, and shows the foil bearing 02 in a state where a shaft 04 rotates and floats from the bearing surface.

FIG. 3 shows a gas film pressure distribution C1, which is a distribution of the pressure of a gas film that is formed between the shaft 4 and a top foil 6 when the shaft 4 rotates and floats from the bearing surface 14, in the cross section of the foil bearing 2 shown in FIG. 1.

FIG. 4 is a diagram schematically showing an example of a cross section orthogonal to the axial direction in the foil bearing 2 according to one embodiment, and schematically shows the cross section of the foil bearing 2 in a state where the rotation of the shaft 4 is stopped.

FIG. 5 is a schematic cross-sectional view showing an example of a more specific configuration of the foil bearing 2 shown in FIG. 1 and the like, and shows an example of a cross section orthogonal to the axial direction in the foil bearing 2 in a state where the shaft 4 rotates and floats from the bearing surface 14.

FIG. 6 is a diagram for describing the influence of thermal elongation of a first base foil portion 10a in the foil bearing 2 shown in FIG. 5, and shows an example of a cross section orthogonal to the axial direction in the foil bearing 2 in a state where the shaft 4 rotates and floats from the bearing surface 14.

FIG. 7 is a schematic cross-sectional view showing an example of a more specific configuration of the foil bearing 2 shown in FIG. 1 and the like, and shows an example of a cross section orthogonal to the axial direction in the foil bearing 2 in a state where the shaft 4 rotates and floats from the bearing surface 14.

FIG. 8 is a diagram for describing the influence of a tensile load acting on a first base foil portion 10c in the foil bearing 2 shown in FIG. 7, and shows an example of a cross section orthogonal to the axial direction in the foil bearing 2 in a state where the shaft 4 rotates and floats from the bearing surface 14.

FIG. 9 is a schematic cross-sectional view showing an example of a more specific configuration of the foil bearing 2 shown in FIG. 1 and the like, and shows an example of a cross section orthogonal to the axial direction in the foil bearing 2.

FIG. 10 is a schematic cross-sectional view showing an example of a configuration of a foil bearing 2 according to another embodiment, and shows an example of a cross section orthogonal to the axial direction in the foil bearing 2.

FIG. 11A is a schematic cross-sectional view showing a part of the foil bearing 2 in a state where the rotation of the shaft 4 is stopped in the foil bearing 2 shown in FIG. 10, and shows an example of a part of a cross section orthogonal to the axial direction in the foil bearing 2.

FIG. 11B is a schematic cross-sectional view showing a part of the foil bearing 2 in a state where the shaft 4 rotates and floats from the bearing surface 14 in the foil bearing 2 shown in FIG. 10, and shows a part of a cross section orthogonal to the axial direction in the foil bearing 2.

FIG. 12 is a schematic cross-sectional view showing an example of a configuration of a foil bearing 2 according to another embodiment, and shows an example of a cross section orthogonal to an axial direction in the foil bearing 2.

FIG. 13 is a schematic diagram showing an example of a rotating machine 50 that includes the foil bearing 2.

### DESCRIPTION OF EMBODIMENTS

Hereinafter, some embodiments of the present disclosure will be described with reference to the accompanying drawings. However, the dimensions, materials, shapes, relative dispositions, and the like of components described as embodiments or shown in the drawings are not intended to limit the scope of the invention and are merely illustrative examples.

For example, an expression indicating relative disposition or absolute disposition, such as “in a direction”, “along a direction”, “parallel”, “orthogonal”, “center”, “concentric”, or “coaxial”, not only strictly represents such disposition, but also represents a state of being relatively displaced with a tolerance, or an angle or a distance to the extent that the same function can be obtained.

For example, expressions such as “identical”, “equal”, and “homogeneous”, which indicate that things are in the same state, not only represent a state of being strictly equal, but also represent a state in which there is a tolerance, or a difference to the extent that the same function can be obtained.

For example, an expression indicating a shape such as a square shape or a cylindrical shape not only represents a shape such as a square shape or a cylindrical shape in a geometrically strict sense, but also represents a shape that includes concave and convex portions, chamfered portions, or the like to the extent that the same effects can be obtained.

Meanwhile, an expression such as “comprising”, “possessing”, “provided with”, “including”, or “having” one component is not an exclusive expression excluding the presence of other components.

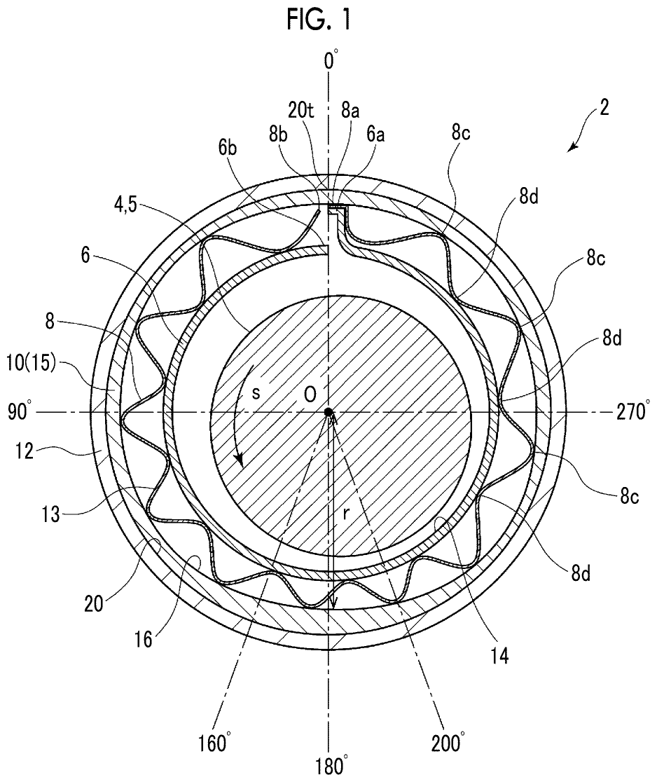

FIG. 1 is a diagram schematically showing an example of a cross section orthogonal to an axial direction in a foil bearing 2 according to one embodiment.

The foil bearing 2 shown in FIG. 1 is a radial bearing that rotatably supports a shaft 4 (a rotary shaft) of a rotating machine, and includes a top foil 6, a bump foil 8, a base foil 10, and a housing 12. FIG. 1 shows a state where the shaft 4 rotates and the shaft 4 floats from a bearing surface 14 of the top foil 6 (a state where the shaft 4 is separated from the bearing surface 14 of the top foil 6).

The housing 12 has a cylindrical shape, and in the following description, unless otherwise specified, the term “circumferential direction” means a circumferential direction of the housing 12, the term “axial direction” means an axial direction of the housing 12, and the term “radial direction” means a radial direction of the housing 12. In addition, the position of an upper end 20t of an inner peripheral surface 20 of the housing 12 is defined as a position of 0° in the circumferential direction, and a rotation direction s of the shaft 4 is defined as a positive direction of the position in the circumferential direction. That is, the position in the circumferential direction increases toward a downstream side in the rotation direction s of the shaft 4 from the position of the upper end 20t (the position of 0°) of the inner peripheral surface 20 of the housing 12. In addition, in the following description, the term “upstream side” means an upstream side in the rotation direction s of the shaft 4, and the term “downstream side” means a downstream side in the rotation direction s of the shaft 4.

As shown in FIG. 1, the housing 12 accommodates a part of the shaft 4, the top foil 6, the bump foil 8, and the base foil 10. That is, the housing 12 is provided to surround a part of the shaft 4, the top foil 6, the bump foil 8, and the base foil 10. The shaft 4, the top foil 6, the bump foil 8, and the base foil 10 are disposed inside the housing 12 in order from an inner side in the radial direction.

The top foil 6 has a substantially cylindrical shape, and is formed, for example, by bending a metal strip-shaped plate material having flexibility into a substantially cylindrical shape. The top foil 6 extends along the circumferential direction and includes the bearing surface 14 (the inner peripheral surface) facing an outer peripheral surface 5 of the shaft 4. One end of the top foil 6 in the circumferential direction is fixed to the housing 12 as a fixed end 6a, and the other end of the top foil 6 in the circumferential direction is a free end 6b. The fixed end 6a is formed by bending one end portion in the circumferential direction of the top foil 6 to a radial outer side. The free end 6b faces the fixed end 6a in a state of being separated from the fixed end 6a in the circumferential direction. Therefore, the top foil 6 is formed in a non-annular shape in which a part in the circumferential direction is cut out such that a space on an inner periphery side of the top foil 6 and a space on an outer periphery side of the top foil 6 communicate with each other between the fixed end 6a and the free end 6b.

The bump foil 8 has a substantially tubular shape, and is curved in a wave shape so as to alternately face an inner side and an outer side in the radial direction toward the other side from one side in the circumferential direction. The bump foil 8 is curved in a wave shape so as to alternately come into contact with the top foil 6 and the base foil 10 toward the other side from the one side in the circumferential direction. The bump foil 8 is formed, for example, by bending a metal strip-shaped plate material having flexibility into a substantially tubular shape. The bump foil 8 extends along the circumferential direction between the top foil 6 and the base foil 10, one end of the bump foil 8 in the circumferential direction is fixed to the housing 12 as a fixed end 8a, and the other end of the bump foil 8 in the circumferential direction is a free end 8b. The free end 8b of the bump foil 8 faces the fixed end 8a in a state of being separated from the fixed end 8a in the circumferential direction of the bump foil 8. Therefore, the bump foil 8 is formed in a non-annular shape in which a part in the circumferential direction is cut out such that a space on an inner periphery side of the bump foil 8 and a space on an outer periphery side of the bump foil 8 communicate with each other between the fixed end 8a and the free end 8b.

The bump foil 8 has a plurality of valley portions 8c and a plurality of peak portions 8d. Each of the valley portions 8c is curved in an arc shape so as to be recessed to a side opposite to the top foil 6 in the radial direction, and is in contact with an inner peripheral surface of the base foil 10. Each of the peak portions 8d is curved in an arc shape so as to protrude toward the top foil 6 side in the radial direction, and is in contact with an outer peripheral surface of the top foil 6. The respective valley portions 8c and the respective peak portions 8d are alternately arranged from the fixed end 8a toward the free end 8b in the circumferential direction.

The base foil 10 is disposed along the inner peripheral surface 20 of the housing 12. The base foil 10 is disposed to face an outer peripheral surface 13 of the bump foil 8, and extends along the circumferential direction to surround the bump foil 8. The base foil 10 has a cylindrical shape, and an outer peripheral surface of the base foil 10 is fixed to the inner peripheral surface 20 of the housing 12 by, for example, welding. The fixed end 8a of the bump foil 8 and the fixed end 6a of the top foil 6 may be fixed to the housing 12 via the base foil 10 by being welded to the base foil 10 in a state of overlapping each other in the radial direction, for example, or may be directly fixed to the housing 12 by welding or the like via a cutout portion (not shown) provided in the base foil 10. In the exemplary form shown in FIG. 1, the fixed end 8a of the bump foil 8 and the fixed end 6a of the top foil 6 are fixed to the housing 12 at the position of 0° in the circumferential direction. In addition, in the exemplary form shown in FIG. 1, the base foil 10 corresponds to a tubular portion 15 that supports the bump foil 8 from the outer periphery side of the bump foil 8.

In the foil bearing 2, when the shaft 4 rotates, the top foil 6 is elastically deformed toward the radial outer side, and a gas (for example, air) enters between the shaft 4 and the bearing surface 14 of the top foil 6 to form a film of a gas (hereinafter, referred to as a “gas film”), and the shaft 4 floats from the bearing surface 14 of the top foil 6 due to a dynamic pressure of the gas film.

The top foil 6 is elastically deformed toward the radial outer side by the gas film between the shaft 4 and the bearing surface 14 of the top foil 6. Then, the top foil 6 presses each peak portion 8d of the bump foil 8, which is in contact with the outer peripheral surface of the top foil 6, to the radial outer side. In this way, the bump foil 8 is elastically deformed toward the radial outer side together with the top foil 6. Therefore, the bump foil 8 elastically supports the top foil 6 from the outer periphery side (radial outer side) of the top foil 6.

In the foil bearing 2 shown in FIG. 1, in a state where the shaft 4 rotates and floats from the bearing surface 14 (for example, in a state where the shaft 4 rotates at a rated rotation speed of a rotating machine including the shaft 4), an average value of distances r between a central axis O of the housing 12 and an inner peripheral surface 16 of the base foil 10 in a range of 160° to 200° in the circumferential direction is smaller than an average value of the distances r between the central axis O of the housing 12 and the inner peripheral surface 16 of the base foil 10 in a range of 0° to 360° in the circumferential direction. In addition, the average value of the distances r between the central axis O of the housing 12 and the inner peripheral surface 16 of the base foil 10 in the range of 160° to 200° in the circumferential direction is smaller than an average value of the distances r between the central axis O of the housing 12 and the inner peripheral surface 16 of the base foil 10 in a range excluding the range of 160° to 200° in the circumferential direction. The range excluding the range of 160° to 200° in the circumferential direction means a range obtained by combining the range of 0° to 160° in the circumferential direction and the range of 200° to 360° in the circumferential direction, and corresponds to a range of −160° to 160° in the circumferential direction. In addition, the distance r between the central axis O of the housing 12 and the inner peripheral surface 16 of the base foil 10 in the range of 0° to 360° in the circumferential direction has a minimum value at a position (a position of 180° or a position in the vicinity of 180° in the illustrated example) within the range of 160° to 200° in the circumferential direction.

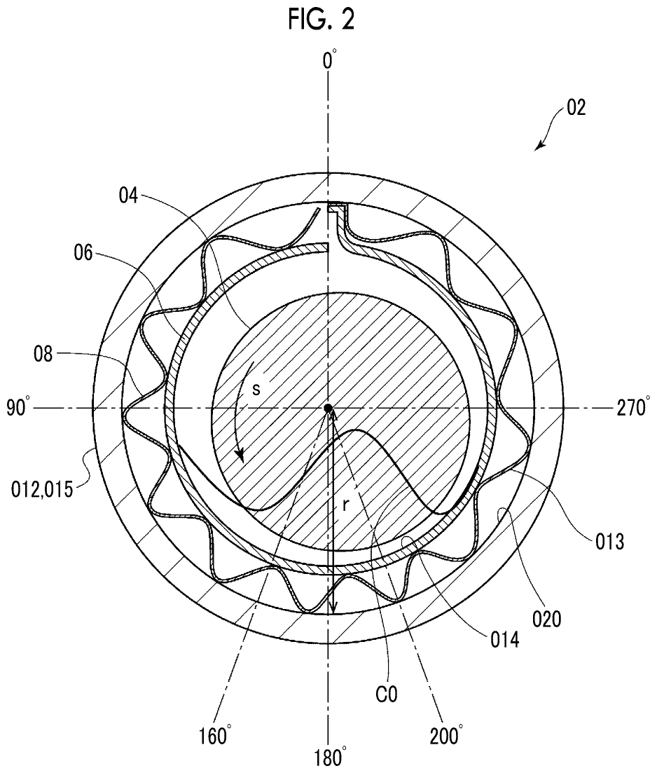

Here, the effect of the foil bearing 2 will be described in comparison with a comparative form shown in FIG. 2.

A foil bearing 02 according to the comparative form shown in FIG. 2 does not include a base foil, an inner peripheral surface 020 of a housing 012 faces an outer peripheral surface 013 of a bump foil 08, and the housing 012 corresponds to a tubular portion 015 that supports the bump foil 08 from an outer periphery side of the bump foil 08. In the comparative form shown in FIG. 2, a distance r between the central axis O of the housing 012 and the tubular portion 015 is constant over the range of 0° to 360° in the circumferential direction.

In FIG. 2, a gas film pressure distribution C0 indicates a distribution of the pressure of a gas film that is formed between a shaft 04 and a top foil 06 when the shaft 04 rotates and floats from a bearing surface 014. The pressure of the gas film increases as a curve indicating the gas film pressure distribution C0 is directed upward with respect to the surface of the top foil 06. That is, the magnitude of a radial distance from the surface of the top foil 06 to the gas film pressure distribution C0 at a certain angular position in the circumferential direction represents the magnitude of the pressure of the gas film at the certain angular position. The larger the radial distance from the surface of the top foil 06 to the gas film pressure distribution C0, the higher the pressure of the gas film becomes.

As shown in the gas film pressure distribution C0 of FIG. 2, in the comparative form, a gas film pressure distribution that is asymmetric with respect to a straight line connecting 0° and 180° in the circumferential direction is generated such that a peak of the gas film pressure is at a position on the downstream side with respect to the position of 180° in the circumferential direction, and as a result, the vibration of each of the shaft 04 and the foil bearing 02 increases.

In a cross section orthogonal to the central axis O of the housing 012, the pressure distribution of the gas film that is formed between the shaft 04 and the top foil 06 in a state where the shaft 04 rotates and floats from the bearing surface 014 has a peak of the pressure of the gas film at a position on the downstream side with respect to the position of 180° in the circumferential direction, and is asymmetric with respect to a straight line connecting 0° and 180° in the circumferential direction. For this reason, the vibration of each of the shaft 04 and the foil bearing 02 has been increased due to the asymmetric pressure distribution. There is a possibility that the gas film pressure distribution can be brought closer to a shape symmetrical with respect to a straight line connecting 0° and 180° in the circumferential direction by reducing the gap (bearing gap) between the top foil 06 and the shaft 04. However, when the bearing gap in an initial state (a state where the rotation of the shaft 04 is stopped) is reduced, there is a concern that the starting torque of the shaft 04 may increase or the coating of the top foil 06 may deteriorate, due to an increase in the contact load of the shaft 04 with respect to the top foil 06.

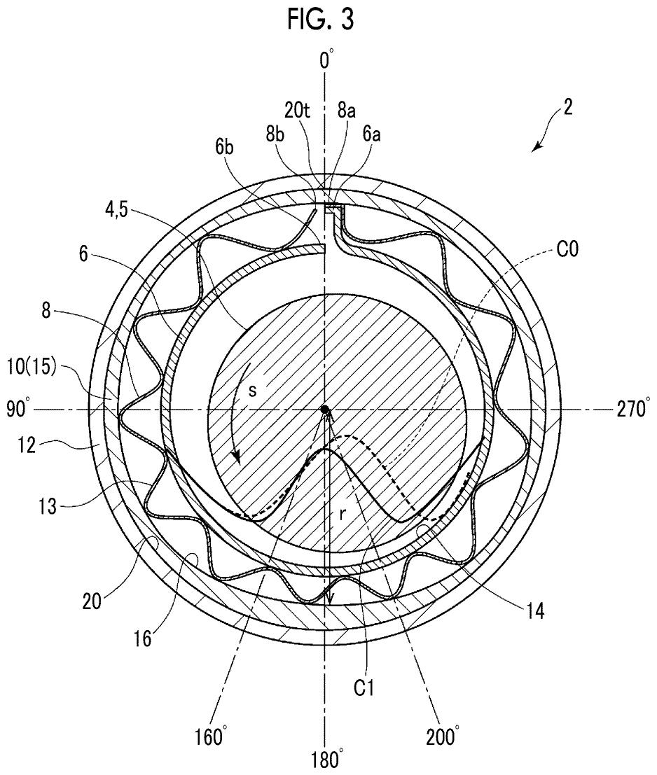

In contrast, in the foil bearing 2 shown in FIG. 1, in a state where the shaft 4 rotates and floats from the bearing surface 14, the average value of the distances r between the central axis O of the housing 12 and the inner peripheral surface 16 of the base foil 10 in the range of 160° to 200° in the circumferential direction (a range in the vicinity of 180° in the circumferential direction) is smaller than the average value of the distances r between the central axis O of the housing 12 and the inner peripheral surface 16 of the base foil 10 in the range of 0° to 360° in the circumferential direction. In this way, the gap between the shaft 4 and the top foil 6 in the range in the vicinity of 180° in the circumferential direction is partially reduced, and thus, as shown in a gas film pressure distribution C1 (the pressure distribution of the gas film that is formed between the shaft 4 and the top foil 6) in FIG. 3, the peak of the pressure of the gas film can be moved to the vicinity of 180°, and the gas film pressure distribution C1 can be brought close to a shape symmetrical with respect to a straight line connecting 0° and 180° in the circumferential direction. Therefore, it is possible to suppress the vibration of each of the shaft 4 and the foil bearing 2. In addition, since it is not necessary to form a complicated pleated shape as in PTL 1 in the bump foil 8, it is possible to suppress the vibration of each of the shaft 4 and the foil bearing 2 with a simple and low-cost configuration. In addition, an increase in a starting torque of the shaft 4 or deterioration of the coating of the top foil 6 can be suppressed as compared with a case where the bearing gap in the initial state (a state where the rotation of the shaft 4 is stopped) is reduced.

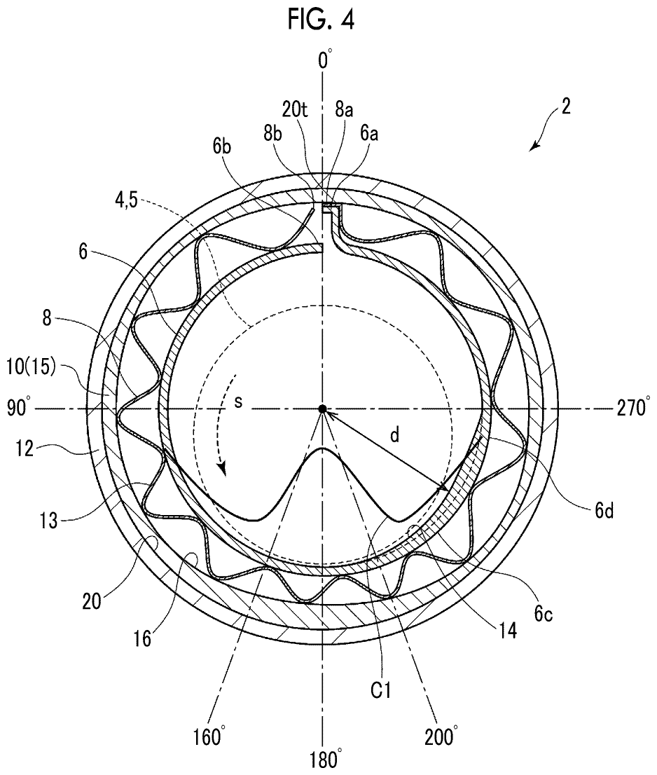

FIG. 4 is a diagram schematically showing an example of a cross section orthogonal to the axial direction in the foil bearing 2 according to one embodiment, and schematically shows a cross section of the foil bearing 2 in a state where the shaft 4 is removed from the foil bearing 2.

In some embodiments, for example, as shown in FIG. 4, in a state where the shaft 4 is removed from the foil bearing 2, the top foil 6 is configured such that a distance d between the central axis O of the housing 12 and the bearing surface 14 of the top foil 6 changes according to a position in the circumferential direction in at least a part of a range of 180° to 270° in the circumferential direction. In addition, in a state where the shaft 4 is removed from the foil bearing 2, an average value of the distances d between the central axis O of the housing 12 and the bearing surface 14 of the top foil 6 in the range of 180° to 270° in the circumferential direction is smaller than an average value of the distances d between the central axis O of the housing 12 and the bearing surface 14 of the top foil 6 in a range of 90° to 180° in the circumferential direction. In addition, in a state where the shaft 4 is removed from the foil bearing 2, the distance d between the central axis O of the housing 12 and the bearing surface 14 of the top foil 6 in the range of 0° to 360° in the circumferential direction has a minimum value in the range of 180° to 270° in the circumferential direction. That is, in a state where the shaft 4 is removed from the foil bearing 2, a minimum value of the distance d between the central axis O of the housing 12 and the bearing surface 14 of the top foil 6 in the range of 180° to 270° in the circumferential direction is smaller than a minimum value of the distance d between the central axis O of the housing 12 and the bearing surface 14 of the top foil 6 in a range excluding the range of 180° to 270° in the circumferential direction.

In the exemplary form shown in FIG. 4, in a state where the rotation of the shaft 4 is stopped, the top foil 6 includes, within a range of 180° to 270° in the circumferential direction, a portion 6c in which the distance d between the central axis O of the housing 12 and the bearing surface 14 of the top foil 6 decreases toward the downstream side in the circumferential direction, and a portion 6d in which the distance d between the central axis O of the housing 12 and the bearing surface 14 of the top foil 6 increases toward the downstream side in the circumferential direction, and the portion 6d is adjacent to the downstream side of the portion 6c in the circumferential direction. In addition, the distance d between the central axis O of the housing 12 and the bearing surface 14 of the top foil 6 has a minimum value at a boundary between the portion 6c and the portion 6d. In addition, the distance d between the central axis O of the housing 12 and the bearing surface 14 of the top foil 6 in the range excluding the range of 180° to 270° in the circumferential direction is constant except for the above-described bent portion configuring the fixed end 6a in the top foil 6. A region where the distance d between the central axis O of the housing 12 and the bearing surface 14 of the top foil 6 is constant may be provided between the portion 6d and the portion 6c.

According to the foil bearing 2 shown in FIG. 4, in a state where the shaft 4 rotates and floats from the bearing surface 14, the bearing surface 14 of the top foil 6 approaches a perfect circle shape in a cross section orthogonal to the axial direction due to thermal deformation of the top foil 6 caused by heat generation. Therefore, the gas film pressure distribution C1 can be made to have a more uniform pressure distribution in a state where the shaft 4 rotates and floats from the bearing surface 14, and thus it is possible to suppress the vibration of each of the shaft 4 and the foil bearing 2 with a simple and low-cost configuration.

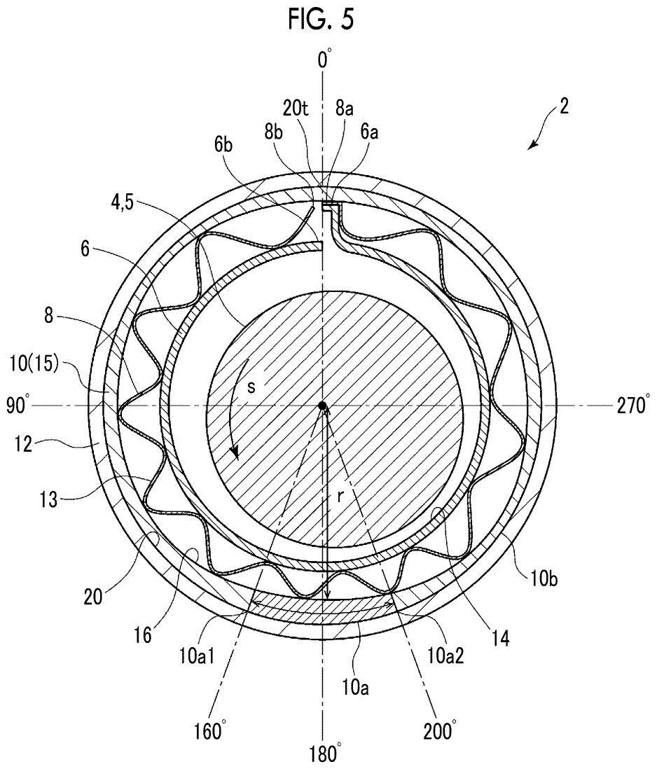

FIG. 5 is a schematic cross-sectional view showing an example of a more specific configuration of the foil bearing 2 shown in FIG. 1 and the like, and shows an example of a cross section orthogonal to the axial direction in the foil bearing 2. FIG. 5 shows the foil bearing 2 in a state where the shaft 4 rotates and floats from the bearing surface 14.

In some embodiments, for example, as shown in FIG. 5, the base foil 10 includes a first base foil portion 10a provided along the circumferential direction in a range including at least a part of a range of 160° to 200° in the circumferential direction, and a second base foil portion 10b connected to both ends 10a1 and 10a2 of the first base foil portion 10a in the circumferential direction. Here, a linear expansion coefficient of the first base foil portion 10a is smaller than a linear expansion coefficient of the second base foil portion 10b, and, for example, the first base foil portion 10a may be formed of a material containing iron, and the second base foil portion 10b may be formed of a material containing copper.

In the exemplary form shown in FIG. 5, the first base foil portion 10a is provided along the circumferential direction in a range of 150° to 210° in the circumferential direction, and more specifically, the first base foil portion 10a is provided in a range including a position of 180° from a position (for example, a position of 160°) between 150° and 180° in the circumferential direction to a position (for example, a position of 200°) between 180° and 210° in the circumferential direction. In addition, the second base foil portion 10b is provided along the circumferential direction over the entirety of a range excluding the range in which the first base foil portion 10a is provided, in the range from 0° to 360° in the circumferential direction. More specifically, the second base foil portion 10b is provided along the circumferential direction in a range from the position of 0° in the circumferential direction to the position of an upstream end 10al of the first base foil portion 10a, and a range from the position of a downstream end 10a2 of the first base foil portion 10a in the circumferential direction to 360°. That is, the second base foil portion 10b is provided along the circumferential direction from the position of the downstream end 10a2 of the first base foil portion 10a in the circumferential direction to the position of the upstream end 10al of the first base foil portion 10a through the position of 360° in the circumferential direction. Each of the first base foil portion 10a and the second base foil portion 10b is fixed to the inner peripheral surface 20 of the housing 12 by, for example, welding or the like.

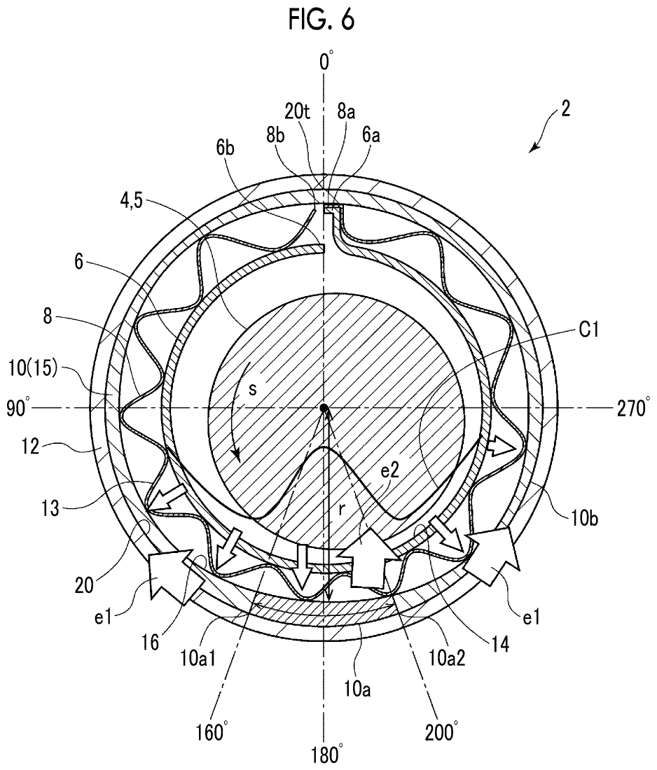

In the foil bearing 2 shown in FIG. 5, when the temperature of the base foil 10 rises due to the rotation of the shaft, the thermal elongation (the thermal elongation indicated by an arrow el in FIG. 6) of the first base foil portion 10a in the circumferential direction, which has a relatively large linear expansion coefficient, is restrained by the second base foil portion 10b, which has a relatively small linear expansion coefficient, and cannot be elongated in the circumferential direction, and the first base foil portion 10a floats to the inner side in the radial direction, as shown by an arrow e2 in FIG. 6. For this reason, in a state where the shaft 4 rotates and floats from the bearing surface 14, the average value of the distances r between the central axis O of the housing 12 and the inner peripheral surface 16 of the base foil 10 in the range of 160° to 200° in the circumferential direction is smaller than the average value of the distances r between the central axis O of the housing 12 and the inner peripheral surface 16 of the base foil 10 in the range of 0° to 360° in the circumferential direction. In addition, the distance r between the central axis O of the housing 12 and the inner peripheral surface 16 of the base foil 10 in the range of 0° to 360° in the circumferential direction has a minimum value at a position (a position of 180° or a position in the vicinity of 180° in the illustrated example) within the range of 160° to 200° in the circumferential direction.

For this reason, the bump foil 8 is lifted to the inner side in the radial direction by the first base foil portion 10a, and the gap between the shaft 4 and the top foil 6 in the range where the first base foil portion 10a is provided in the circumferential direction is narrowed. Therefore, the peak of the pressure of the gas film moves to the vicinity of 180°, and thus the gas film pressure distribution C1 can be brought close to a shape symmetrical with respect to a straight line connecting 0° and 180° in the circumferential direction, and the vibration of each of the shaft 4 and the foil bearing 2 can be suppressed with a simple and low-cost configuration. In addition, as described above, materials having different linear expansion coefficients are used for the first base foil portion 10a and the second base foil portion 10b, so that it is possible to adjust the thickness of the base foil 10 at a low cost without requiring complicated processing.

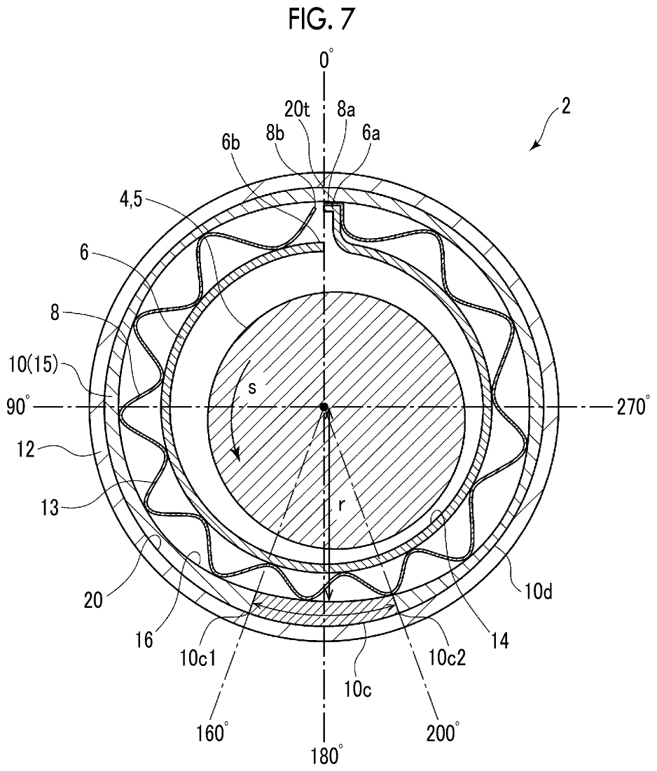

FIG. 7 is a schematic cross-sectional view showing an example of a more specific configuration of the foil bearing 2 shown in FIG. 1 and the like, and shows an example of a cross section orthogonal to the axial direction in the foil bearing 2. FIG. 7 shows the foil bearing 2 in a state where the shaft 4 rotates and floats from the bearing surface 14.

In some embodiments, for example, as shown in FIG. 7, the base foil 10 includes a first base foil portion 10c provided along the circumferential direction in a range including at least a part of a range of 160° to 200° in the circumferential direction, and a second base foil portion 10d connected to both ends 10c1 and 10c2 of the first base foil portion 10c in the circumferential direction. Here, the first base foil portion 10c is formed of a material having a negative Poisson's ratio, and is configured such that the thickness (thickness in the radial direction) of the first base foil portion 10c increases with respect to a tensile load in the circumferential direction.

In the exemplary form shown in FIG. 7, the first base foil portion 10c is provided along the circumferential direction within a range of 150° to 210° in the circumferential direction, and more specifically, the first base foil portion 10c is provided in a range including a position of 180° from a position (for example, a position of 160°) between 150° and 180° in the circumferential direction to a position (for example, a position of 200°) between 180° and 200° in the circumferential direction. In addition, the second base foil portion 10d is provided along the circumferential direction over the entirety of a range excluding the range in which the first base foil portion 10c is provided, in the range of 0° to 360° in the circumferential direction. More specifically, the second base foil portion 10d is provided along the circumferential direction in a range from the position of 0° in the circumferential direction to a position of an upstream end 10c1 of the first base foil portion 10c, and a range from a position of a downstream end 10c2 of the first base foil portion 10c in the circumferential direction to 360°. That is, the second base foil portion 10d is provided along the circumferential direction from the position of the downstream end 10c2 of the first base foil portion 10c in the circumferential direction to the position of the upstream end 10c1 of the first base foil portion 10c through the position of 360° in the circumferential direction. Each of the first base foil portion 10c and the second base foil portion 10d is fixed to the inner peripheral surface 20 of the housing 12 by, for example, welding.

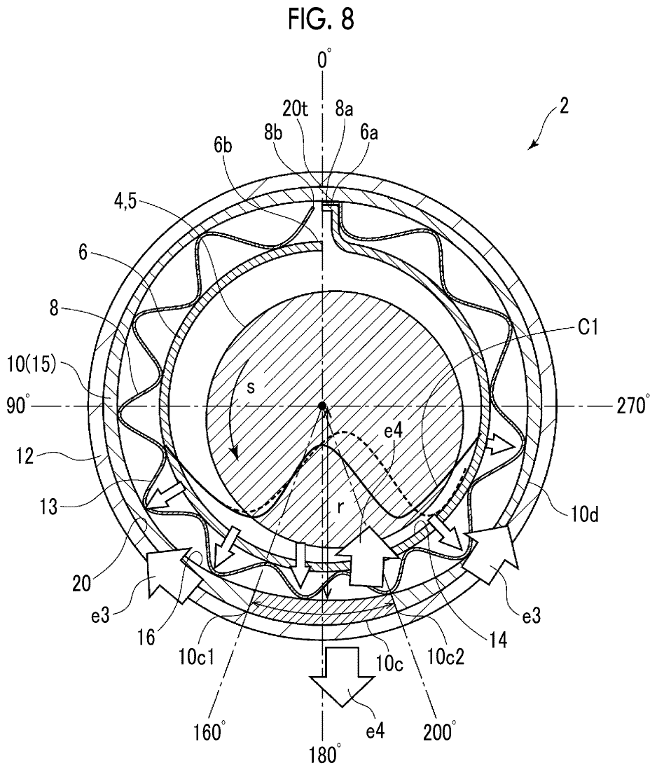

In the foil bearing 2 shown in FIG. 7, when the shaft 4 rotates, a gas film is formed between the shaft 4 and the top foil 6 and a gas film pressure distribution is generated. Therefore, the base foil 10 receives a load on the inner peripheral surface 20 and receives a tensile load in the circumferential direction, as indicated by an arrow e3 in FIG. 8. As a result, as indicated by an arrow e4 in FIG. 8, the thickness (thickness in the radial direction) of the first base foil portion 10c increases in the vicinity of 180° in the circumferential direction. For this reason, in a state where the shaft 4 rotates and floats from the bearing surface 14, the average value of the distances r between the central axis O of the housing 12 and the inner peripheral surface 16 of the base foil 10 in the range of 160° to 200° in the circumferential direction is smaller than the average value of the distances r between the central axis O of the housing 12 and the inner peripheral surface 16 of the base foil 10 in the range of 0° to 360° in the circumferential direction. In addition, the distance r between the central axis O of the housing 12 and the inner peripheral surface 16 of the base foil 10 in the range of 0° to 360° in the circumferential direction has a minimum value at a position (a position of 180° or a position in the vicinity of 180° in the illustrated example) within the range of 160° to 200° in the circumferential direction.

For this reason, the bump foil 8 is lifted to the inner side in the radial direction by the first base foil portion 10c, and the gap between the shaft 4 and the top foil 6 in the range where the first base foil portion 10c is provided in the circumferential direction is narrowed. Therefore, the peak of the pressure of the gas film moves to the vicinity of 180°, and thus the gas film pressure distribution C1 can be brought close to a shape symmetrical with respect to a straight line connecting 0° and 180° in the circumferential direction, and the vibration of each of the shaft 4 and the foil bearing 2 can be suppressed with a simple and low-cost configuration.

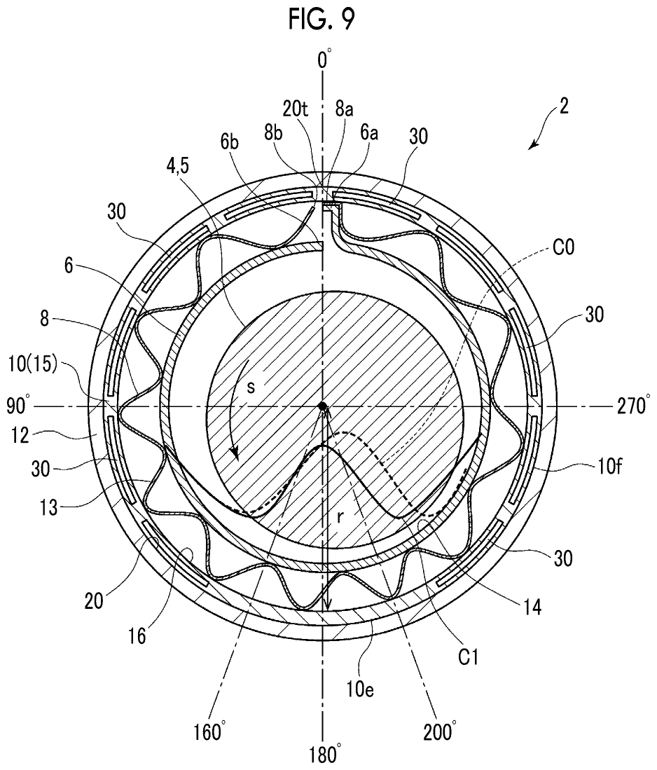

FIG. 9 is a schematic cross-sectional view showing an example of a more specific configuration of the foil bearing 2 shown in FIG. 1 and the like, and shows an example of a cross section orthogonal to the axial direction in the foil bearing 2.

In some embodiments, for example, as shown in FIG. 9, at least one slit 30 is formed in the base foil 10 in at least a part of a range excluding a range of 160° to 200°, in a range of 0° to 360° in the circumferential direction. In the exemplary form shown in FIG. 9, a plurality of slits 30 are formed at intervals in the circumferential direction within a range of 0° to 160° in the circumferential direction, and a plurality of slits 30 are formed at intervals in the circumferential direction within a range of 200° to 360° in the circumferential direction. That is, a plurality of slits 30 are formed at intervals in the circumferential direction within a range of- 160° to 160° in the circumferential direction. Each of the slits 30 extends along the circumferential direction. In addition, the slits 30 are not formed in a range of 160° to 200° in the circumferential direction. For this reason, the rigidity of a portion 10e of the base foil 10 that belongs to the range of 160° to 200° in the circumferential direction is higher than the rigidity of a portion 10f of the base foil 10 that belongs to the range excluding the range of 160° to 200° in the circumferential direction, and the portion 10f of the base foil 10, in which the slit 30 in the circumferential direction is formed, is easily deformed to the outer side in the radial direction by the force received from the bump foil 8, whereas the portion 10e of the base foil 10, in which the slit 30 is not formed, is less likely to be deformed to the outer side in the radial direction even when a force is received from the bump foil 8.

In the foil bearing 2 shown in FIG. 9, in a state where the rotation of the shaft 4 is stopped (an initial state of the foil bearing 2), the inner diameter of the base foil 10 is constant regardless of a position in the circumferential direction. However, in a state where the shaft 4 rotates and floats from the bearing surface 14, the top foil 6 and the bump foil 8 are displaced to the outer side in the radial direction due to the pressure of the gas film that is formed between the shaft 4 and the top foil 6, and a force outward in the radial direction acts on the inner peripheral surface of the base foil 10. For this reason, in a state where the shaft 4 rotates and floats from the bearing surface 14, the average value of the distances r between the central axis O of the housing 12 and the inner peripheral surface 16 of the base foil 10 in a range of 160° to 200° in the circumferential direction (a range in which the rigidity of the base foil 10 is relatively high) is smaller than the average value of the distances r between the central axis O of the housing 12 and the inner peripheral surface 16 of the base foil 10 in a range excluding the range of 160° to 200° in a range of 0° to 360° in the circumferential direction (a range in which the rigidity of the base foil 10 is relatively low). In addition, the distance r between the central axis O of the housing 12 and the inner peripheral surface 16 of the base foil 10 in the range of 0° to 360° in the circumferential direction has a minimum value at a position (a position of 180° or a position in the vicinity of 180° in the illustrated example) within the range of 160° to 200° in the circumferential direction.

Therefore, the gap between the shaft 4 and the top foil 6 in a range in the vicinity of 180° in the circumferential direction is partially reduced, so that the peak of the pressure of the gas film can be moved to the vicinity of 180°, and the gas film pressure distribution C1 can be brought close to a shape symmetrical with respect to a straight line connecting 0° and 180° in the circumferential direction. Therefore, it is possible to suppress the vibration of each of the shaft 4 and the foil bearing 2 with a simple and low-cost configuration. In addition, for example, compared to the configuration shown in FIG. 5, since the base foil 10 can be formed of one material, it is possible to suppress the vibration of each of the shaft 4 and the foil bearing 2 with a lower cost configuration.

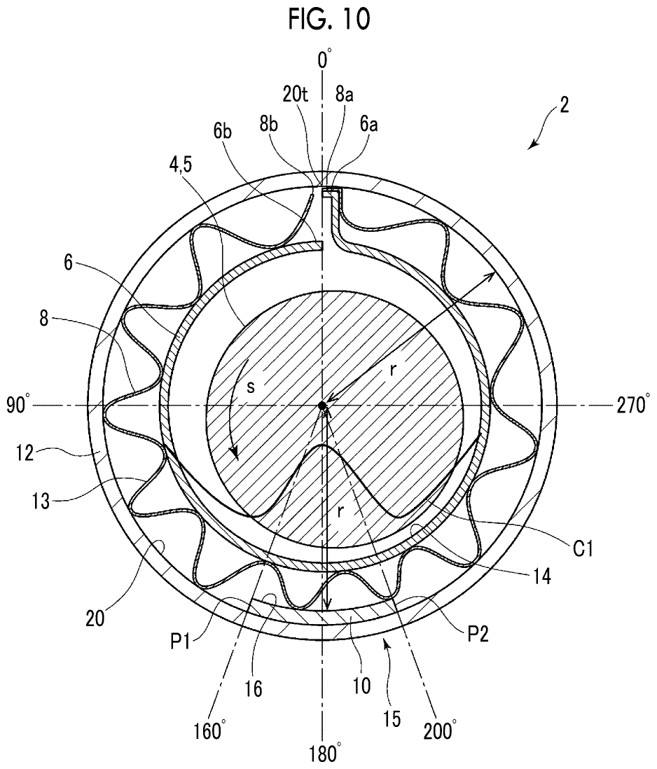

FIG. 10 is a schematic cross-sectional view showing an example of a configuration of a foil bearing 2 according to another embodiment, and shows an example of a cross section orthogonal to the axial direction in the foil bearing 2.

In the embodiment shown in FIG. 10, the base foil 10 is provided in a range including at least a part of a range of 160° to 200° in the circumferential direction. More specifically, the base foil 10 is provided in a range including a position of 180° from a position P1 (for example, a position of 160°) between 150° and 180° in the circumferential direction to a position P2 (for example, a position of 200°) between 180° and 210° in the circumferential direction, and is not provided in a range from the position P2 in the circumferential direction to the position P1 through 360°. For this reason, the inner peripheral surface 20 of the housing 12 includes a portion facing the outer peripheral surface 13 of the bump foil 8 on both sides of the range in which the base foil 10 is provided in the circumferential direction. Therefore, in the embodiment shown in FIG. 10, in the range in which the base foil 10 is provided in the circumferential direction, the base foil 10 faces the bump foil 8 and the base foil 10 supports the bump foil 8, and in the range in which the base foil 10 is not provided in the circumferential direction, the housing 12 faces the bump foil 8 and the housing 12 supports the bump foil 8. In addition, the rigidity of the top foil 6 is higher than the rigidity of the bump foil 8, and the rigidity of the base foil 10 is higher than the rigidity of the top foil 6. In the embodiment shown in FIG. 10, the base foil 10 and the housing 12 configure the tubular portion 15 that supports the bump foil 8 from the outer periphery side of the bump foil 8.

Also in the configuration shown in FIG. 10, in a state where the shaft 4 rotates and floats from the bearing surface 14, the average value of the distances r between the central axis O of the housing 12 and the inner peripheral surface of the tubular portion 15 in a range of 160° to 200° in the circumferential direction is smaller than the average value of the distances r between the central axis O of the housing 12 and the inner peripheral surface of the tubular portion 15 in a range of 0° to 360° in the circumferential direction. The distance r between the central axis O of the housing 12 and the inner peripheral surface of the tubular portion 15 is the distance between the central axis O and the inner peripheral surface 16 of the base foil 10 in the range where the base foil 10 is provided in the circumferential direction, and is the distance between the central axis O and the inner peripheral surface 20 of the housing 12 in the range where the base foil 10 is not provided in the circumferential direction.

In addition, in a state where the shaft rotates and floats from the bearing surface, the distance r between the central axis O of the housing 12 and the inner peripheral surface of the tubular portion 15 in a range of 0° to 360° in the circumferential direction has a minimum value at a position (a position of 180° or a position in the vicinity of 180° in the illustrated example) within a range of 160° to 200° in the circumferential direction.

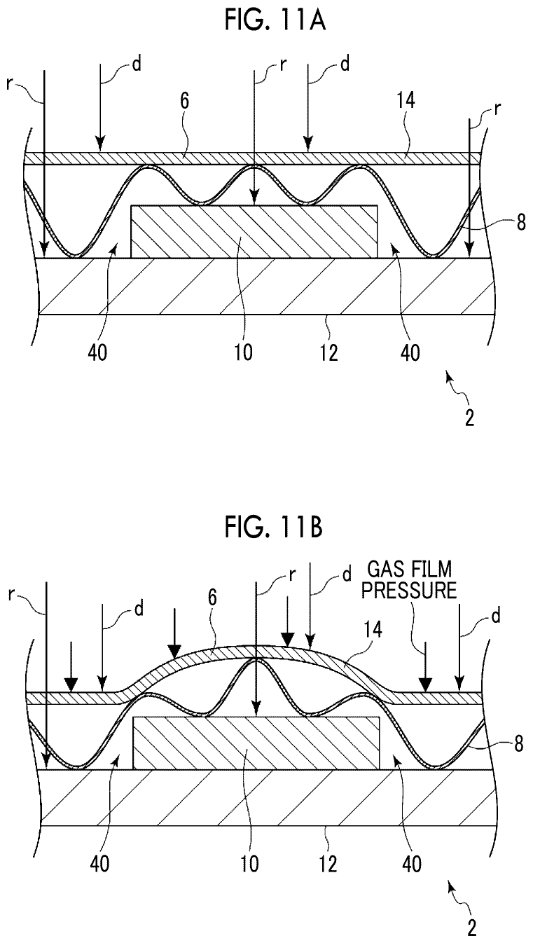

In the foil bearing 2 shown in FIG. 10, in a state where the rotation of the shaft 4 is stopped, as shown in FIG. 11A, the influence of steps 40 that are formed at both ends of the base foil 10 in the circumferential direction due to a thickness t of the base foil 10 is absorbed by the deformation of the bump foil 8, and thus the influence of the steps 40 does not appear in the shape of the top foil 6. In contrast, in a state where the shaft 4 rotates and floats from the bearing surface 14, as shown in FIG. 11B, the top foil 6 and the bump foil 8 are pressed to the outer side in the radial direction by the pressure of the gas film between the shaft 4 and the top foil 6 and are deformed according to the step 40. Therefore, a distance d between the central axis of the housing 12 and the bearing surface 14 of the top foil 6 in the range where the base foil 10 is provided in the circumferential direction becomes smaller than a distance d between the central axis of the housing 12 and the bearing surface 14 of the top foil 6 in the range where the base foil 10 is not provided in the circumferential direction.

Therefore, the gap between the shaft 4 and the top foil 6 in the range where the base foil 10 is provided in the circumferential direction is partially reduced, so that the peak of the pressure of the gas film can be moved to the vicinity of 180°, and the gas film pressure distribution C1 can be brought close to a shape symmetrical with respect to a straight line connecting 0° and 180° in the circumferential direction. Therefore, it is possible to suppress the vibration of each of the shaft 4 and the foil bearing 2 with a simple and low-cost configuration.

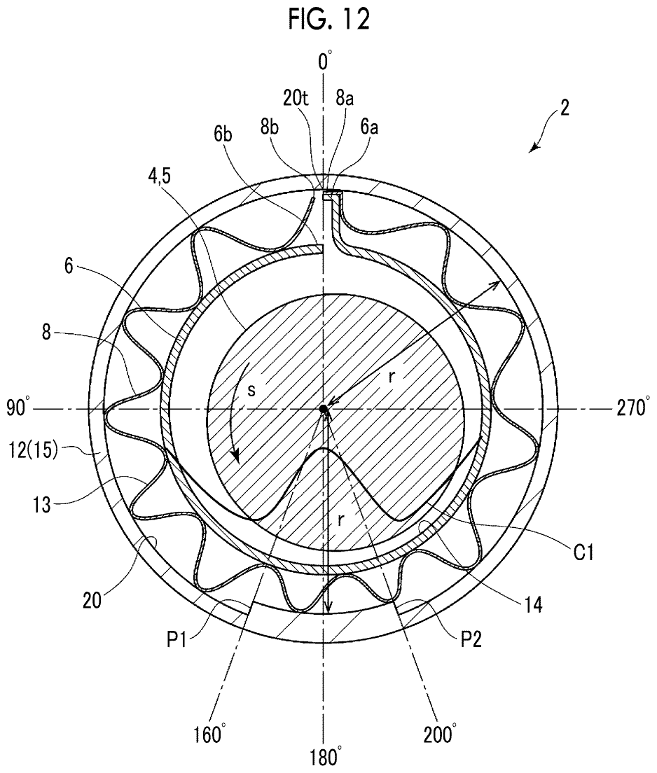

FIG. 12 is a schematic cross-sectional view showing an example of a configuration of a foil bearing 2 according to another embodiment, and shows an example of a cross section orthogonal to the axial direction in the foil bearing 2.

In the embodiment shown in FIG. 12, the foil bearing 2 does not include a base foil, and the housing 12 configures the tubular portion 15 that supports the bump foil 8 from the outer periphery side of the bump foil 8.

In the foil bearing 2 shown in FIG. 12, the average of the inner diameters r of the housing 12 in a range of 160° to 200° in the circumferential direction is smaller than the average of the inner diameters r of the housing 12 in a range of 0° to 360° in the circumferential direction. That is, the average of the inner diameters r of the housing 12 in the range of 160° to 200° in the circumferential direction is smaller than the average of the inner diameters r of the housing 12 in a range excluding the range of 160° to 200° in the circumferential direction (a range of- 160° to 160° in the circumferential direction). In the configuration shown in FIG. 12, more specifically, the inner diameter r of the housing 12 in a range including 180° from the position P1 (for example, the position of 160°) between 150° and 180° in the circumferential direction to the position P2 (for example, the position of 200°) between 180° and 210° in the circumferential direction is smaller than the inner diameter r of the housing 12 in the range from the position P1 in the circumferential direction to the position P2 through the position of 360°.

Also in the configuration shown in FIG. 12, in a state where the shaft 4 rotates and floats from the bearing surface 14, the average value of the distances r between the central axis O of the housing 12 and the inner peripheral surface of the tubular portion 15 (the inner peripheral surface 20 of the housing 12) in the range of 160° to 200° in the circumferential direction is smaller than the average value of the distances r between the central axis O of the housing 12 and the inner peripheral surface of the tubular portion 15 (the inner peripheral surface 20 of the housing 12) in the range of 0° to 360° in the circumferential direction. In addition, the distance r between the central axis O of the housing 12 and the inner peripheral surface of the tubular portion 15 (the inner peripheral surface 20 of the housing 12) in the range of 0° to 360° in the circumferential direction has a minimum value at a position (a position of 180° or a position in the vicinity of 180° in the illustrated example) within a range of 160° to 200° in the circumferential direction. Therefore, for the same reason as the configuration shown in FIGS. 10, 11A, and 11B, the peak of the pressure of the gas film is moved to the vicinity of 180°, so that the gas film pressure distribution C1 can be brought close to a shape symmetrical with respect to a straight line connecting 0° and 180° in the circumferential direction, and the vibrations of each of the shaft 4 and the foil bearing 2 can be suppressed with a simple and low-cost configuration.

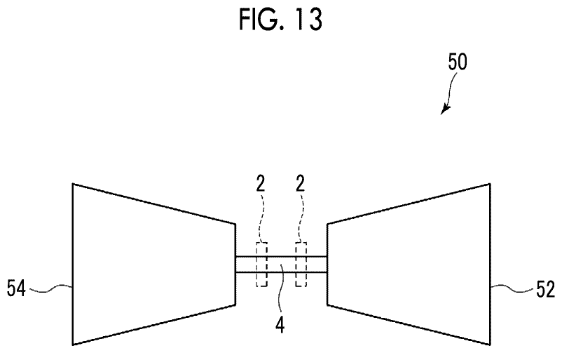

FIG. 13 is a schematic diagram showing an example of a rotating machine 50 that includes the foil bearing 2 according to each of the embodiments described above. In the exemplary form shown in FIG. 13, the rotating machine 50 is a turbocharger, and includes a turbine 52, a compressor 54 connected to the turbine 52 via the shaft 4, and a pair of foil bearings 2 that rotatably support the shaft 4. Each of the pair of foil bearings 2 is provided at each of positions separated from each other in the axial direction in the shaft 4.

The present disclosure is not limited to the embodiments described above, and includes modified forms of the embodiments described above or forms in which these embodiments are combined as appropriate.

For example, although a turbocharger is shown as an example of the rotating machine to which the foil bearing is applied, the rotating machine to which the foil bearing is applied is not limited to the turbocharger, and may be, for example, a turbine, a compressor, or the like.

The contents described in each of the embodiments described above are understood as follows, for example.
(1) A foil bearing (for example, the foil bearing 2 described above) according to at least one embodiment of the present disclosure includes:
a top foil (for example, the top foil 6 described above) that includes a bearing surface (for example, the bearing surface 14 described above) facing a shaft (for example, the shaft 4 described above);
a bump foil (for example, the bump foil 8 described above) that supports the top foil from an outer periphery side of the top foil; and
a tubular housing (for example, the housing 12 described above) that accommodates the top foil and the bump foil,
in which the foil bearing includes a tubular portion (for example, the tubular portion 15 described above) that surrounds the bump foil and that supports the bump foil from an outer periphery side of the bump foil, and
when in a cross section orthogonal to a central axis of the housing, a position of an upper end (for example, the upper end 20t described above) of an inner peripheral surface of the housing is defined as a position of 0° in a circumferential direction of the housing and a rotation direction of the shaft is defined as a positive direction of a position in the circumferential direction,
in a state where the shaft rotates and floats from the bearing surface, in the cross section orthogonal to the central axis of the housing, an average value of distances between the central axis of the housing and an inner peripheral surface of the tubular portion in a range of 160° to 200° in the circumferential direction is smaller than an average value of distances between the central axis of the housing and the inner peripheral surface of the tubular portion in a range of 0° to 360° in the circumferential direction.

In the foil bearing of the related art, in a cross section orthogonal to the central axis of the housing, the pressure distribution of the gas film that is formed between the shaft and the top foil in a state where the shaft rotates and floats from the bearing surface has a peak of the pressure of the gas film at a position on the downstream side with respect to the position of 180° in the circumferential direction, and is asymmetric with respect to a straight line connecting 0° and 180° in the circumferential direction. For this reason, the vibration of each of the shaft and the foil bearing has increased due to the asymmetric pressure distribution of the gas film. In contrast, according to the foil bearing of the above (1), in a state where the shaft rotates and floats from the bearing surface, the average value of the distances between the central axis of the housing and the inner peripheral surface of the tubular portion in the range of 160° to 200° in the circumferential direction (a range in the vicinity of 180° in the circumferential direction) is smaller than the average value of the distances between the central axis of the housing and the inner peripheral surface of the tubular portion in the range of 0° to 360° in the circumferential direction. Therefore, compared to a case where the distance between the central axis of the housing and the inner peripheral surface of the tubular portion in a state where the shaft rotates and floats up from the bearing surface is constant in the range of 0° to 360° in the circumferential direction, a bearing gap (a gap between the shaft and the top foil) in a state where the shaft rotates and floats up from the bearing surface can be partially reduced in the vicinity of 180° in the circumferential direction. In this way, the peak of the pressure of the gas film in the cross section orthogonal to the central axis of the housing can be moved to the vicinity of 180°, and the pressure distribution of the gas film can be brought close to a shape symmetrical with respect to a straight line connecting 0° and 180° in the circumferential direction. Therefore, it is possible to suppress the vibration of each of the shaft and the foil bearing. In addition, since it is not necessary to form a complicated pleated shape as in PTL 1 in the bump foil, it is possible to suppress the vibration of each of the shaft and the foil bearing with a simple and low-cost configuration. In addition, it is possible to suppress an increase in the starting torque of the shaft or deterioration of the coating of the top foil, compared to a case where the bearing gap in an initial state (a state where the rotation of the shaft is stopped) is reduced.
(2) In some embodiments, in the foil bearing of the above (1), in a state where the shaft rotates and floats from the bearing surface, a distance between the central axis of the housing and the inner peripheral surface of the tubular portion has a minimum value at a position within the range of 160° to 200° in the circumferential direction.

According to the foil bearing of the above (2), the peak of the pressure of the gas film in a cross section orthogonal to the central axis of the housing can be moved to the vicinity of 180°, and the pressure distribution of the gas film can be brought close to a shape symmetrical with respect to a straight line connecting 0° and 180° in the circumferential direction. Therefore, it is possible to suppress the vibration of each of the shaft and the foil bearing. In addition, since it is not necessary to form a complicated pleated shape as in PTL 1 in the bump foil, it is possible to suppress the vibration of each of the shaft and the foil bearing with a simple and low-cost configuration.
(3) In some embodiments, in the foil bearing of the above (1) or (2),
in a state where the shaft is removed from the foil bearing, an average value of distances between the central axis of the housing and an inner peripheral surface of the top foil in a range of 180° to 270° in the circumferential direction is smaller than an average value of distances between the central axis of the housing and the inner peripheral surface of the top foil in a range of 90° to 180° in the circumferential direction.

According to the foil bearing of the above (3), in a state where the shaft rotates and floats from the bearing surface, the bearing surface of the top foil approaches a perfect circle shape in a cross section orthogonal to the axial direction due to thermal deformation of the top foil caused by heat generation. For this reason, the gas film pressure distribution can be made more uniform in a state where the shaft rotates and floats from the bearing surface, and therefore, it is possible to effectively suppress the vibration of each of the shaft and the foil bearing with a simple configuration.
(4) In some embodiments, in the foil bearing of any one of the above (1) to (3),
in a state where the shaft is removed from the foil bearing, a distance between the central axis of the housing and an inner peripheral surface of the top foil has a minimum value at a position within a range of 180° to 270° in the circumferential direction.

According to the foil bearing of the above (4), in a state where the shaft rotates and floats from the bearing surface, the top foil is thermally deformed due to heat generation, and the cross section of the bearing surface of the top foil (a cross section orthogonal to the axial direction) approaches a perfect circle shape. For this reason, the gas film pressure distribution can be made more uniform in a state where the shaft rotates and floats from the bearing surface, and therefore, it is possible to effectively suppress the vibration of each of the shaft and the foil bearing with a simple and low-cost configuration.

(5) In some embodiments, in the foil bearing of any one of the above (1) to (4),
the tubular portion includes a base foil (for example, the base foil 10 described above) disposed along the inner peripheral surface of the housing.

According to the foil bearing of the above (5), it is possible to suppress the vibration of each of the shaft and the foil bearing with a simple configuration and at a low cost.
(6) In some embodiments, in the foil bearing of the above (5),
the base foil includes
   a first base foil portion (for example, the first base foil portion 10a described above) provided along the circumferential direction in a range including at least a part of the range of 160° to 200° in the circumferential direction, and
   at least one second base foil portion (for example, the second base foil portion 10b described above) connected to both ends of the first base foil portion in the circumferential direction, and
a linear expansion coefficient of the first base foil portion is smaller than a linear expansion coefficient of the second base foil portion.

According to the foil bearing of the above (6), when the temperature of the base foil rises due to the rotation of the shaft, the thermal elongation in the circumferential direction of the first base foil portion having a relatively large linear expansion coefficient is restrained by the second base foil portion having a relatively small linear expansion coefficient, and the first base foil portion floats to the inner side in the radial direction. For this reason, in a state where the shaft rotates and floats from the bearing surface, the average value of the distances between the central axis of the housing and the inner peripheral surface of the base foil in the range of 160° to 200° in the circumferential direction becomes smaller than the average value of the distances between the central axis of the housing and the inner peripheral surface of the base foil in the range of 0° to 360° in the circumferential direction. Therefore, the bump foil is lifted to the inner side in the radial direction by the first base foil portion, and the gap between the shaft and the top foil in the range in which the first base foil portion is provided in the circumferential direction is narrowed. Therefore, the peak of the pressure of the gas film moves to the vicinity of 180°, so that the gas film pressure distribution can be brought close to a shape symmetrical with respect to a straight line connecting 0° and 180° in the circumferential direction, and the vibration of each of the shaft and the foil bearing can be suppressed with a simple and low-cost configuration. In addition, as described above, materials having different linear expansion coefficients are used for the first base foil portion and the second base foil portion, so that it is possible to adjust the thickness of the base foil at a low cost without requiring complicated processing.
(7) In some embodiments, in the foil bearing of the above (5) or (6),
rigidity of a portion of the base foil that belongs to the range of 160° to 200° in the circumferential direction is higher than rigidity of a portion of the base foil that belongs to a range excluding the range of 160° to 200° in the circumferential direction.

According to the foil bearing of the above (7), when the base foil receives a force to the radial outer side due to the pressure of the gas film that is formed between the shaft and the top foil during the rotation of the shaft, the base foil is more likely to be compressed and deformed in the radial direction in the range of 160° to 200° in the circumferential direction than in a range excluding the range of 160° to 200° in the circumferential direction. For this reason, in a state where the shaft rotates and floats from the bearing surface, the average value of the distances between the central axis of the housing and the inner peripheral surface of the base foil in the range of 160° to 200° in the circumferential direction (a range in which the rigidity of the base foil is relatively high) becomes smaller than the average value of the distances between the central axis of the housing and the inner peripheral surface of the base foil in the range of 0° to 360° in the circumferential direction. Therefore, as described above, it is possible to suppress the vibration of each of the shaft and the foil bearing with a simple and low-cost configuration.
(8) In some embodiments, in the foil bearing of the above (5) or (7),
at least one slit (for example, the plurality of slits 30 described above) is formed in the base foil in at least a part of a range excluding the range of 160° to 200° in the circumferential direction.

According to the foil bearing of the above (8), the rigidity of the portion belonging to a range excluding the range of 160° to 200° in the circumferential direction in the base foil can be reduced with a simple configuration. In this way, the configuration and the effect of the above (7) can be realized with a simple configuration. In addition, for example, compared to the configuration shown in the above (5), the base foil can be formed of one material. Therefore, it is possible to suppress the vibration of each of the shaft and the foil bearing with a lower cost configuration.
(9) In some embodiments, in the foil bearing of the above (5),
the base foil is provided in a range including at least a part of the range of 160° to 200° in the circumferential direction,
the tubular portion is configured with the base foil and the housing, and
the inner peripheral surface of the housing includes a portion facing the bump foil on both sides of a range in which the base foil is provided in the circumferential direction.

According to the foil bearing of the above (9), when the shaft rotates, the top foil and the bump foil are pressed to the outer side in the radial direction by the pressure of the gas film between the shaft and the top foil, so that the amount of deformation of the top foil and the base foil to the outer side in the radial direction becomes larger in the range on both sides of the range in which the base foil is provided in the circumferential direction (the range in which the base foil is not provided) than in the range in which the base foil is provided in the circumferential direction. Therefore, in a state where the shaft rotates and floats from the bearing surface, the bearing gap (the gap between the shaft and the top foil) in the range in which the base foil is provided in the circumferential direction can be made smaller than the bearing gap in the range on both sides of the base foil in the circumferential direction. In this way, the peak of the pressure of the gas film in the cross section orthogonal to the central axis of the housing can be moved to the vicinity of 180°, and the pressure distribution of the gas film can be brought close to a shape symmetrical with respect to a straight line connecting 0° and 180° in the circumferential direction. Therefore, it is possible to suppress the vibration of each of the shaft and the foil bearing with a simple and low-cost configuration.
(10) In some embodiments, in the foil bearing of any one of the above (1) to (4),
an average of inner diameters of the housing in the range of 160° to 200° in the circumferential direction is smaller than an average of inner diameters of the housing in the range of 0° to 360° in the circumferential direction.

According to the foil bearing of the above (10), when the shaft rotates, the top foil and the bump foil are pressed to the outer side in the radial direction by the pressure of the gas film between the shaft and the top foil, so that the amount of deformation of the top foil and the base foil to the outer side in the radial direction becomes larger in the range in which the inner diameter of the housing in the circumferential direction is relatively large than in the range in which the inner diameter of the housing in the circumferential direction is relatively small. Therefore, in a state where the shaft rotates and floats from the bearing surface, the bearing gap (the gap between the shaft and the top foil) in the vicinity of 180° in the circumferential direction can be made smaller than the bearing gap in the other range in the circumferential direction. In this way, the peak of the pressure of the gas film in the cross section orthogonal to the central axis of the housing can be moved to the vicinity of 180°, and the pressure distribution of the gas film can be brought close to a shape symmetrical with respect to a straight line connecting 0° and 180° in the circumferential direction. Therefore, it is possible to suppress the vibration of each of the shaft and the foil bearing with a simple and low-cost configuration.
(11) A rotating machine (for example, the rotating machine 50 described above) according to at least one embodiment of the present disclosure includes: the foil bearing of any one of the above (1) to (10); and the shaft.

According to the rotating machine of the above (11), since the foil bearing of any one of the above (1) to (10) is provided, it is possible to suppress the vibration of each of the shaft and the foil bearing with a simple and low-cost configuration.

### REFERENCE SIGNS LIST

2: foil bearing
4: shaft
5: outer peripheral surface
6: top foil
6a, 8a: fixed end
6b, 8b: free end
6c, 6d, 10e, 10f: portion
8: bump foil
8c: valley portion
8d: peak portion
10: base foil
10a, 10c: first base foil portion
10a1, 10cl: upstream end
10a2, 10c2: downstream end
10b, 10d: second base foil portion
12: housing
13: outer peripheral surface
14: bearing surface
15: tubular portion
16, 20: inner peripheral surface
20t: upper end
30: slit
40: step
50: rotating machine
52: turbine
54: compressor

1. A foil bearing comprising:
a top foil that includes a bearing surface facing a shaft;
a bump foil that supports the top foil from an outer periphery side of the top foil; and
a tubular housing that accommodates the top foil and the bump foil,
wherein the foil bearing includes a tubular portion that surrounds the bump foil and that supports the bump foil from an outer periphery side of the bump foil, and
when in a cross section orthogonal to a central axis of the housing, a position of an upper end of an inner peripheral surface of the housing is defined as a position of 0° in a circumferential direction of the housing and a rotation direction of the shaft is defined as a positive direction of a position in the circumferential direction,
in a state where the shaft rotates and floats from the bearing surface, in the cross section orthogonal to the central axis of the housing, an average value of distances between the central axis of the housing and an inner peripheral surface of the tubular portion in a range of 160° to 200° in the circumferential direction is smaller than an average value of distances between the central axis of the housing and the inner peripheral surface of the tubular portion in a range of 0° to 360° in the circumferential direction.

2. The foil bearing according to claim 1, wherein in a state where the shaft rotates and floats from the bearing surface, a distance between the central axis of the housing and the inner peripheral surface of the tubular portion has a minimum value at a position within the range of 160° to 200° in the circumferential direction.

3. The foil bearing according to claim 1, wherein in a state where the shaft is removed from the foil bearing, an average value of distances between the central axis of the housing and an inner peripheral surface of the top foil in a range of 180° to 270° in the circumferential direction is smaller than an average value of distances between the central axis of the housing and the inner peripheral surface of the top foil in a range of 90° to 180° in the circumferential direction.

4. The foil bearing according to claim 1, wherein in a state where the shaft is removed from the foil bearing, a distance between the central axis of the housing and an inner peripheral surface of the top foil has a minimum value at a position within a range of 180° to 270° in the circumferential direction.

5. The foil bearing according to claim 1, wherein the tubular portion includes a base foil disposed along the inner peripheral surface of the housing.

6. The foil bearing according to claim 5,
wherein the base foil includes
a first base foil portion provided along the circumferential direction in a range including at least a part of the range of 160° to 200° in the circumferential direction, and
at least one second base foil portion connected to both ends of the first base foil portion in the circumferential direction, and
a linear expansion coefficient of the first base foil portion is smaller than a linear expansion coefficient of the second base foil portion.

7. The foil bearing according to claim 5, wherein rigidity of a portion of the base foil that belongs to the range of 160° to 200° in the circumferential direction is higher than rigidity of a portion of the base foil that belongs to a range excluding the range of 160° to 200° in the circumferential direction.

8. The foil bearing according to claim 5, wherein at least one slit is formed in the base foil in at least a part of a range excluding the range of 160° to 200° in the circumferential direction.

9. The foil bearing according to claim 5,
wherein the base foil is provided in a range including at least a part of the range of 160° to 200° in the circumferential direction,
the tubular portion is configured with the base foil and the housing, and
the inner peripheral surface of the housing includes a portion facing the bump foil on both sides of a range in which the base foil is provided in the circumferential direction.

10. The foil bearing according to claim 1, wherein an average of inner diameters of the housing in the range of 160° to 200° in the circumferential direction is smaller than an average of inner diameters of the housing in the range of 0° to 360° in the circumferential direction.

11. A rotating machine comprising:
the foil bearing according to claim 1; and
the shaft.
